(19) United States
(12) Patent Application Publication
(10) Pub. No.: US 2019/0371142 A1
(43) Pub. Date: Dec. 5, 2019

(54) PATHWAY DETERMINATION BASED ON MULTIPLE INPUT FEEDS

(71) Applicant: WIZR LLC, Santa Monica, CA (US)

(72) Inventors: David CARTER, Marina del Rey, CA (US); Genquan DUAN, Los Angeles, CA (US)

(73) Assignee: WIZR LLC, Santa Monica, CA (US)

(21) Appl. No.: 16/408,253

(22) Filed: May 9, 2019

Related U.S. Application Data
(60) Provisional application No. 62/668,932, filed on May 9, 2018.

(51) Int. Cl. G08B 13/196

(52) U.S. Cl. CPC G08B 13/19608; G08B 13/19669

(57) ABSTRACT

Multiple input feeds are used to make a pathway determination in systems using artificial intelligence engines in connection with video cameras, associated video streams, and other sensors. The system obtains a video stream and information specifying a location of the video stream. An event is detected in the video stream, such as movement of an individual, movement of an automobile, criminal activity, an emergency situation, etc. The system also obtains a detection signal and location thereof, such as information from a sensor in a heat detecting device, a sound detecting device, or a camera. Based on the foregoing information, the system identifies a possible future location for an event, such as the movement of the detected individual, automobile, etc.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of a system 100 for pathway determination based on multiple input feeds.

FIG. 2 is a flowchart of an example process for pathway determination based on multiple input feeds according to some embodiments.

FIG. 3 shows an illustrative computational system for performing functionality to facilitate implementation of embodiments described herein.

### DETAILED DESCRIPTION

Systems and methods are disclosed for pathway determination based on multiple input feeds.

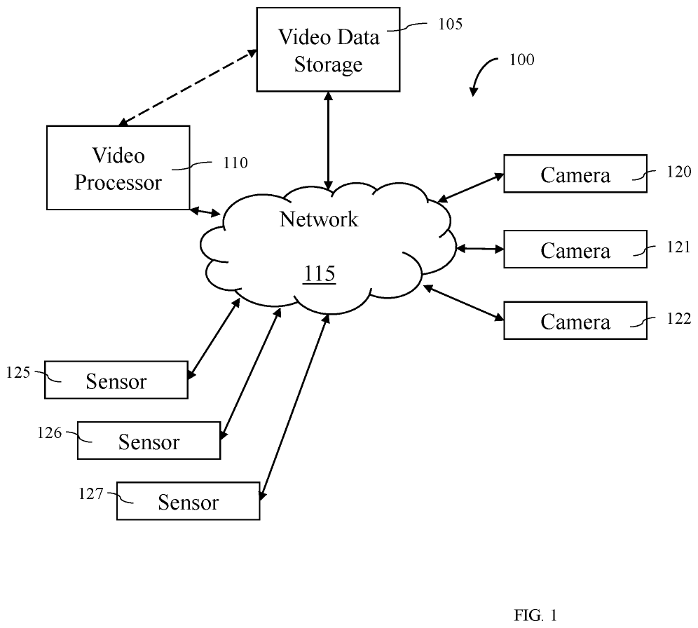

FIG. 1 illustrates a block diagram of a system 100 that may be used in various embodiments. The system 100 may include a plurality of cameras: camera 120, camera 121, and camera 122. While three cameras 120, 121, and 122 are shown, any number of cameras may be included. These cameras 120, 121, and 122 may include any type of video camera such as, for example, a wireless video camera, a black and white video camera, surveillance video camera, portable cameras, battery powered cameras, CCTV cameras, Wi-Fi enabled cameras, smartphones, smart devices, tablets, computers, GoPro cameras, wearable cameras, etc. The cameras 120, 121, and 122 may be positioned anywhere such as, for example, within the same geographic location, in separate geographic locations, positioned to record portions of the same scene, positioned to record different portions of the same scene, etc. In some embodiments, the cameras 120, 121, and 122 may be owned and/or operated by different users, organizations, companies, entities, etc.

The cameras 120, 121, and 122 may be coupled with the network 115. The network 115 may, for example, include the Internet, a telephonic network, a wireless telephone network, a 3G network, etc. In some embodiments, the network may include multiple networks, connections, servers, switches, routers, connections, etc. that may enable the transfer of data. In some embodiments, the network 115 may be or may include the Internet. In some embodiments, the network may include one or more LAN, WAN, WLAN, MAN, SAN, PAN, EPN, and/or VPN.

In some embodiments, one more of the cameras 120, 121, and 122 may be coupled with a base station, digital video recorder, or a controller that is then coupled with the network 115.

The system 100 may also include multiple sensors: sensor 125, sensor 126, and sensor 127. While three sensors 125, 126, and 127 are shown, any number of sensors may be included. These sensors 125, 126, and 127 may include any type of sensor such as, for example, a video camera, a motion detector, a heat detector, a noise detector, a light detector, a tripwire, a laser tripwire, etc. The sensors 125, 126, and 127 may be positioned anywhere such as, for example, within the same geographic location, in separate geographic locations, positioned to sense portions of the same scene, positioned to sense different portions of the same scene, etc. In some embodiments, the sensors 125, 126, and 127 may be owned and/or operated by different users, organizations, companies, entities, etc.

The sensors 125, 126, and 127 may be coupled with the network 115. In some embodiments, one or more of the sensors 125, 126, and 127 may be coupled with a base station, a signal record, or a controller that is then coupled with the network 115.

The system 100 may also include video data storage 105 and/or a video processor 110. In some embodiments, the video data storage 105 and the video processor 110 may be coupled together via a dedicated communication channel that is separate than or part of the network 115. In some embodiments, the video data storage 105 and the video processor 110 may share data via the network 115. In some embodiments, the video data storage 105 and the video processor 110 may be part of the same system or systems.

In some embodiments, the video data storage 105 may include one or more remote or local data storage locations such as, for example, a cloud storage location, a remote storage location, etc.

In some embodiments, the video data storage 105 may store video files recorded by one or more of camera 120, camera 121, and camera 122. In some embodiments, the video files may be stored in any video format such as, for example, mpeg, avi, etc. In some embodiments, video files from the cameras may be transferred to the video data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, the video data storage 105 may store signal data received by one or more of sensor 125, sensor 126, and sensor 127. In some embodiments, the signal data may be stored in any data format.

In some embodiments, the video data storage 105 may store user identified event data reported by one or more individuals. The user identified event data may be used, for example, to train the video processor 110 to capture feature events.

In some embodiments, a video file may be recorded and stored in memory located at a user location prior to being transmitted to the video data storage 105. In some embodiments, a video file may be recorded by the camera 120, 121, and 122 and streamed directly to the video data storage 105.

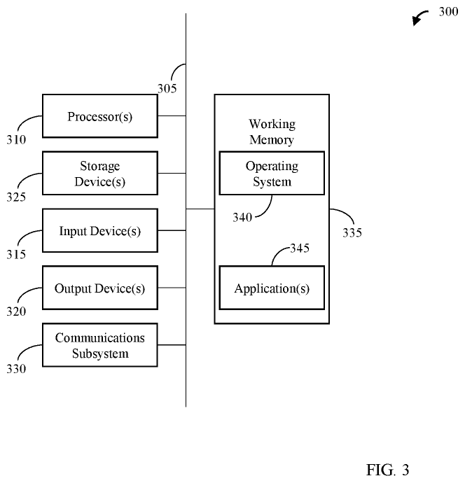

In some embodiments, the video processor 110 may include one or more local and/or remote servers that may be used to perform data processing on videos stored in the video data storage 105. In some embodiments, the video processor 110 may execute one more algorithms on one or more video files stored with the video storage location. In some embodiments, the video processor 110 may execute a plurality of algorithms in parallel on a plurality of video files stored within the video data storage 105. In some embodiments, the video processor 110 may include a plurality of processors (or servers) that each execute one or more algorithms on one or more video files stored in video data storage 105. In some embodiments, the video processor 110 may include one or more of the components of computational system 300 shown in FIG. 3.

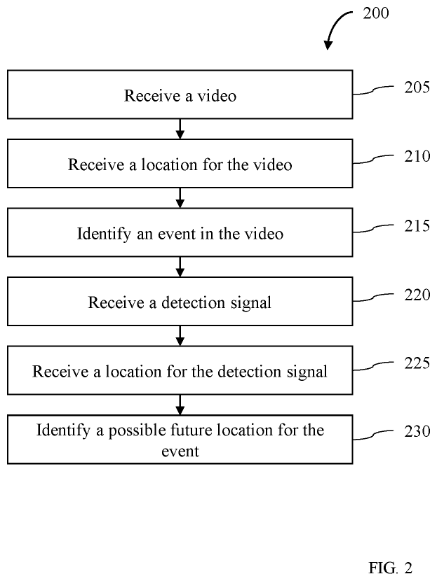

FIG. 2 is a flowchart of an example process 200 for pathway determination based on camera feed and other data. One or more steps of the process 200 may be implemented, in some embodiments, by one or more components of system 100 of FIG. 1, such as the video processor 110. Although illustrated as discrete blocks, various blocks may be divided into additional blocks, combined into fewer blocks, or eliminated, depending on the desired implementation.

Process 200 may begin at block 205. At block 205 the system 100 may receive a video. In some embodiments, the video may be a video stream from a camera such as, for example, camera 120, camera 121, and/or camera 122. The video, for example, may be received as an mjpeg video stream, h264 video stream, VP8 video stream, MP4, FLV, WebM, ASF, ISMA, flash, HTTP Live Streaming, etc. Various other streaming formats and/or protocols may be used.

In some embodiments, at block 210 the video processor 110 may receive a location for the video. In these and other embodiments, the location for the video may be the location of a camera 120, 121, and 122 from which the video was received. In these and other embodiments, the location may be a location from a GPS device that may be attached to or nearby the camera 120, 121, and 122. In some embodiments, the location for the video may be determined based on the video and/or based on a second video. For example, in some embodiments the location for one video may be determined based on a known location for another video. In some embodiments, the location for the video may be entered by a user. For example, a user may enter the location of each video on map which may be received by the video processor 110.

In some embodiments, at block 215 the video processor 110 may identify an event in the video. In some embodiments, the event may include movement of an individual, movement of an automobile, criminal activity, an emergency situation, and/or other activity that may be tracked by a video feed. For example, in some embodiments, the event may be the movement of people in a building in response to an emergency situation such as a fire. In some embodiments, the event may be an individual breaking into a home or business.

In some embodiments, at block 220 the video processor 110 may receive a detection signal. In some embodiments, a detection signal may be a signal from a sensor 125, 126, or 127 in a motion detecting device, a signal from a heat detecting device, a signal from a sound detecting device, another video and/or a signal from another detection device. For example, in some embodiments a home or business may have a security camera outside the building that may generate a video. The home or business may also include a motion detecting device inside the building. The motion detecting device may send a signal that motion has been detected. Alternatively or additionally, in some embodiments, the detection device may be a smoke detector. In these and other embodiments, the detection device may provide a detection signal to the video processor.

In some embodiments, at block 225 the video processor 110 may receive a location for the detection signal. In these and other embodiments, the location for the detection signal may be the location of a sensor 125, 126, 127 or camera 120, 121, and 122 from which the detection signal was received. In these and other embodiments, the location may be a location from a GPS device that may be attached to or nearby the sensor 125, 126, 127 or camera 120, 121, and 122. In some embodiments, the location for the detection signal may be determined based on the detection signal and/or based on a video stream. In some embodiments, the location for the detection signal may be entered by a user. For example, a user may enter the location of each detection signal on a map which may be received by the video processor.

In some embodiments, at block 230 the video processor 110 may identify a possible future location for the event. In these and other embodiments, the video processor 110 may identify the possible future location for the event based on the video feed received at block 205 and the detection signal received at block 220. For example, in some embodiments, the event may include the movement of a human. The video processor 110 may determine that the human is moving in a certain direction. A signal may be received in the direction the human is moving. The video processor 110 may determine that the human followed a path from where the human is identified in the video feed to the location of the detection signal.

In some embodiments, the video processor 110 may identify a possible past location for the event based on the video feed received at block 205 and the detection signal received at block 220. For example, in some embodiments, the event may include the movement of a human. The video processor 110 may determine that the human is moving from a certain direction. A signal may be received in the direction from which the human is moving. The video processor 110 may determine that the human followed a path from the location of the detection signal to where the human is identified in the video feed.

In some embodiments, the detection signal may be a signal from a smoke detector. In these and other embodiments, the event in the video may be an individual moving towards the detection signal. For example, the individual may be an emergency responder and may be attempting to put out the fire or other source of the smoke detection signal. Alternatively or additionally, the individual may not be an emergency responder but may be moving towards the detection signal to help others. By identifying a potential future location for the person and/or by determining a potential path taken by the person, it may be easier to account for individuals in emergency situations. Alternatively, the event in the video may be an individual moving away from the detection signal. For example, the individual may be an employee at the location where the smoke detection signal originated. The employee may be attempting to flee from a fire. By determining a potential past location for the individual and/or by determining a potential path taken by the individual, it may be easier to identify a location for the source of a problem.

In these and other embodiments, the video processor 110 may generate a virtual reality and/or augmented reality representation of the movement of the event between the location for the video stream and the location for the detection signal. In some embodiments, the video processor 110 may receive a layout of a building which may include the location for the video stream and the location for the detection signal. In these and other embodiments, the video processor 110 may use the layout of the building to construct a virtual representation of the inside of the building. In some embodiments, the event may be criminal activity. In these and other embodiments, the video processor 110 may be able to identify a possible past location for the criminal activity, i.e. the video processor 110 may be able to determine where the individuals who engaged in the criminal activity were prior to the criminal activity. In these and other embodiments, the video processor 110 may be configured to identify a pathway of the event across multiple video streams and/or multiple detection signals. In these and other embodiments, identifying possible future locations and/or possible past locations may help emergency responders identify where to look for humans who may be involved in a possible emergency situation.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 200 may further include triggering an abnormal event notification in response to a difference between an actual future location for the event and the possible future location for the event being greater than a difference threshold. For example, the method 200 may identify a possible future location for the event in block 230. In some embodiments, after identifying a possible future location for the event, an actual future location for the event may be observed. In these and other embodiments, the actual future location may match the possible future location or be within a difference threshold of the possible future location. Alternatively or additionally, in some embodiments, the actual future location may not match the possible future location or be within a difference threshold of the possible future location. For example, the method 200 may identify a possible future location for a criminal after the commission of a crime. The criminal may be identified in an actual future location, for example through identification in a video stream from a camera. Alternatively or additionally, in some embodiments, event may include people leaving from a burning building. The possible future location may be a location on a path from where the people were originally located to the outside of the building. If the people are identified in an actual future location that is not on a path towards the outside of the building, the abnormal event may be triggered. In some embodiments, the triggering of the abnormal event may be accompanied by sounds, lights, or other indications to alert the individuals to change direction. For example, in some embodiments, a voice may tell the individuals to turn around. Alternatively or additionally, in some embodiments, arrows may point the individuals

The possible future location and the actual future location may be compared. In some embodiments, the possible future location and the actual future location may differ by more than a difference magnitude. In these and other embodiments, an abnormal event may be triggered. For example, a notification may be provided. The notification may indicate the actual future location of the event. Alternatively or additionally, in some embodiments, the method 200 may further be configured to use the actual future location to improve the machine learning algorithm for the identification of possible future locations.

In some embodiments, the method 200 may further include generating a predicted path to the possible future location from a current location. In these and other embodiments, the predicted path may be generated by identifying multiple possible paths from the current location to the possible future location. In these and other embodiments, the multiple possible paths may be prioritized based on a degree of safety associated with the paths, a time associated with traversing the paths, or other factors. For example, paths that are safer and faster may be prioritized higher than paths that are safe but not fast, fast but not safe, or neither fast nor safe. In these and other embodiments, safety may be determined based on obstructions or conditions that may be present in the path. For example, paths that include high vertical drops may be identified as being less safe than paths with no vertical drops. Similarly, paths that include hazardous conditions such as a fire may be identified as less safe than paths without hazardous conditions. In some embodiments, the method 200 may further include presenting the predicted path to a user. In these and other embodiments, emergency response teams, for example the police or fire department, may use the predicted path to quickly reach individuals in need of assistance. Alternatively or additionally, individuals may use the predicted path to reach a place of safety in the event of an emergency condition. In these and other embodiments, visual, audio, or smell instructions may be provided to the individuals to direct the individuals to follow the path. For example, verbal instructions may be played over a speaker system directing the individuals on the directions to take to follow the predicted path. Alternatively or additionally, lights or sounds may be presented to the individuals directing the individuals concerning the predicted path. Alternatively or additionally, verbal instructions may include additional information to help the individuals protect themselves in the emergency situation.

The computational system 300 (or processing unit) illustrated in FIG. 3 can be used to perform and/or control operation of any of the embodiments described herein. For example, the computational system 300 can be used alone or in conjunction with other components. As another example, the computational system 300 can be used to perform any calculation, solve any equation, perform any identification, and/or make any determination described here.

The computational system 300 may include any or all of the hardware elements shown in the figure and described herein. The computational system 300 may include hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard, and/or the like; and one or more output devices 320, which can include, without limitation, a display device, a printer, and/or the like.

The computational system 300 may further include (and/or be in communication with) one or more storage devices 325, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 300 might also include a communications subsystem 340, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 340 may permit data to be exchanged with a network (such as the network described below, to name one example) and/or any other devices described herein. In many embodiments, the computational system 300 will further include a working memory 335, which can include a RAM or ROM device, as described above.

The computational system 300 also can include software elements, shown as being currently located within the working memory 335, including an operating system 340 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

In some cases, the storage medium might be incorporated within the computational system 300 or in communication with the computational system 300. In other embodiments, the storage medium might be separate from the computational system 300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 300 and/or might take the form of source and/or installable code, which, upon compilation and/or installation on the computational system 300 (e.g., using any of a variety of generally available compilers, installation programs, compression/decompression utilities, etc.), then takes the form of executable code.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1.-3. (canceled)

4. A method for pathway determination based on multiple input feeds, the method comprising:
receiving a video;
receiving a location for the video;
identifying an event in the video;
receiving a detection signal;
receiving a location for the detection signal; and
identifying a possible future location for the event.

5. The method of claim 4, further comprising:
triggering an abnormal event if a difference between an actual future location for the event and the possible future location for the event is greater than a threshold difference.

6. The method of claim 4, further comprising:
generating a predicted safe and fast path to the possible future location from a current location.

7. The method of claim 4, wherein receiving the video comprises receiving the video from a security camera.

8. The method of claim 7, wherein receiving the detection signal comprises receiving the detection signal from sensor separate from the camera.

9. The method of claim 8, wherein the sensor is one of a heat detecting device, a sound detecting device, or a second camera separate from the camera from which the video is received.

10. The method of claim 4, wherein identifying a possible future location for the event comprises calculating a predicted pathway of an entity identified in the video.

11. The method of claim 10, wherein the entity identified in the video is one of a person and an automobile.
